(19) United States
(12) Patent Application Publication
(10) Pub. No.: US 2011/0084982 A1
(43) Pub. Date: Apr. 14, 2011

(54) Apparatus and Method for Displaying Image Data With Memory Reduction

(75) Inventors: Bryan Mihalov, San Diego, CA (US); Takaaki Ota, San Diego, CA (US)

(73) Assignees: SONY CORPORATION, Tokyo (JP); SONY ELECTRONICS INC., Park Ridge, NJ (US)

(21) Appl. No.: 12/577,585

(22) Filed: Oct. 12, 2009

(51) Int. Cl. G09G 5/377

(52) U.S. Cl. 345/629

(57) ABSTRACT

An apparatus and method are provided for displaying image data with memory reduction. In one embodiment, a method includes receiving a first image by the device, displaying the first image on a display of the device and scaling image data of the first image. The device may scale image data to generate scaled image data having reduced pixel data with respect to the first image. The method may also include receiving a second image by the device, generating composite image data based on the scaled image data of the first image and image data of the second image, and displaying the composite image data on the display of the device. The second image may then be displayed an the display of the device.

### FIELD OF THE INVENTION

The present invention relates generally to displaying image data, and more particularly to reducing memory required for displaying a series of images.

### BACKGROUND OF THE INVENTION

In recent years, advances in image sensor technology have led to increases in image quality and image resolution. Current imaging devices can capture images demanding nearly 30 megabytes (MB) of memory for a single image. Processing of these images may be memory intensive. As a result, display of image data by conventional methods requires memory capable of storing image data for large images. Memory required for processing multiple images may be prohibitively expensive for some devices. This may be especially true for embedded devices. Nevertheless, displaying multiple images is a feature that many users desire.

Thus, there exists a desire for display of a plurality of images on devices while reducing memory required for display operations.

### BRIEF SUMMARY OF THE INVENTION

Disclosed and claimed herein are methods and apparatus for displaying image data. In one embodiment, a method includes receiving a first image by the device, displaying the first image on a display of the device, and sealing image data of the first image to generate scaled image data having reduced pixel data with respect to the first image. The method further includes receiving a second image by the device, generating composite image data based on the scaled image data of the first image and image data of the second image, and displaying the composite image data on the display of the device. The method further includes displaying the second image on the display of the device.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a simplified block diagram of a device according to one embodiment;

FIG. 2 depicts a graphical representation of image sealing according to one embodiment;

FIG. 3A depicts a graphical representation of image display according to one embodiment;

FIG. 3B depicts a graphical representation of image display according to another embodiment;

FIG. 4 depicts a process for image transition with memory reduction according to one or more embodiments;

FIG. 5 depicts a graphical representation of image display according to one or more embodiments; and

FIGS. 6A-6C depict block diagrams for image display according to one or more embodiments.

### DETAILED DESCRIPTION OF THE EXEMPLARY EMBODIMENTS

### Overview and Terminology

One aspect of the present invention relates to operation of a device for displaying image data. In one embodiment, a process is provided for displaying a plurality of images. The process may be initiated by receiving and displaying a first image by the device. According to one embodiment, image data of the first image may be scaled by the device to generate composite data. By scaling image data, the memory required for processing and/or generating a display of the image data may be reduced. As used herein scaling image data may relate to adjusting resolution of an image. Scaling may relate to down-scaling of image data wherein data of the image is reduced, such as reducing pixel data. Alternatively, or in combination, scaling may relate to upscaling of image data, wherein image display size may be increased without substantially increasing image file size, such as stretching image data. As a result, scaled image data may be stored and processed with less memory than in relation to memory required for display of original image data.

The process may include receiving a second image by the device and generating composite image data based on the down-scaled image data of the first image and image data of the second image. Composite image data may be displayed during a transition period between display of the first and second images. In that fashion, memory required for display of the first and second images to provide composite data does not require the amount of memory that would be required for generating composite data based on the images as originally received. In another embodiment, image data of the second image may be scaled prior to generating composite image data.

In another embodiment, image data may be down-scaled and then upscaled to generate composite image data for a transition effect between display of a first and second images. Display of composite image data may provide a visually stimulating transition between display of a series of images while reducing the memory required for processing image data.

According to another embodiment, a device is provided for display of image data. The device may be configured to scale image data, wherein memory of the device required for image display may be less than memory required for displaying of original image data that is not scaled.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

### Exemplary Embodiments

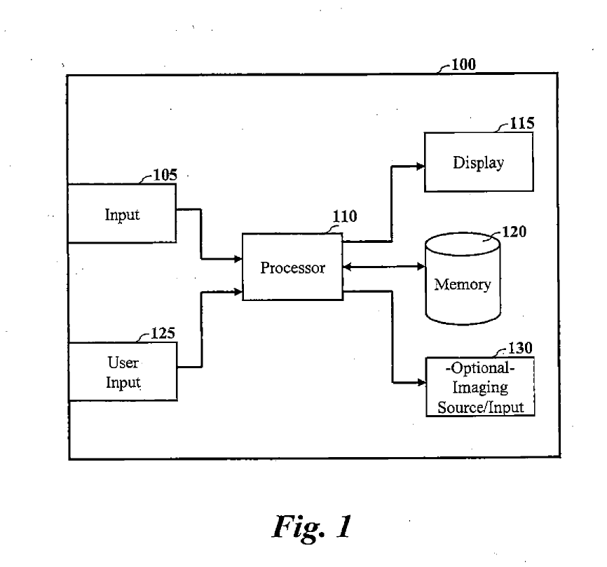

Referring now to the figures, FIG. 1 depicts a simplified block diagram of a device configured for displaying image data according to one embodiment of the invention. Device 100 may relate to one or more of a computing device, personal communication device, media player and display device in general. According to one embodiment, display device 100 may be configured to display one or more images in series, such as an image slideshow for stored and/or received images. Device 100 may be configured to provide a transition between display of a first and second images while reducing memory required for image display. By scaling image data of at least one image, memory required for generating composite data for display during image transition is greatly reduced in comparison to generating composite image data for two original images. Accordingly, one advantage of the present invention over conventional methods and devices allows for less memory in comparison to display of original sized images. Also, memory of the device may be reserved for operations performed by the device when a series of images are displayed.

As shown in FIG. 1, device 100 includes processor 110 coupled to input 105, display 115 and memory 120. One or more images received by input 105 may be provided to professor 110 for output on display 115 and memory 120. In one embodiment, input 105 may relate to a video input connection configured to receive image data for display. In one embodiment, device 100 may relate to a television, wherein input 105 may be coupled to an auxiliary device such as a computer, media player, imaging device, etc. Alternatively, device 100 may include an optional imaging source/input relating to a disc reader (e.g., CD, DVD, etc.) or media reader configured to retrieve one or more images. Device 100 may be configured to display image data related to one or more image file types (e.g., JPEG, TIFF, GIF, BMP, Exif, RAW, Rastor, resolution dependent, etc.).

Memory 120 of device 100 relates to one of a RAM and flash memory. Memory 120 may be configured to store and retrieve one or more operating instructions for processor 110. According to another embodiment, memory 120 may store and retrieve image data for output by device 100. Memory 120 of device 100 may be configured to provide one or more buffers for image data. For example, memory 120 may include an image buffer for temporary storage of sealed image data and/or a frame buffer for storage of image data for display.

User interface 125 of device 100 may be configured to receive one or more input commands from a user. User interface 125 may include one or more buttons and/or relate to a graphical user interface displayed on display 115. In one embodiment user interface 125 may receive one or more commands from a user to initiate display of one or more images by device 100. According to another embodiment, user interface may be employed by a user to set time periods for display of image data including composite data between display of images.

According to another embodiment, device 100 may be configured to receive image data over a network, connection such as the internet (e.g., LAN and WAN, etc.) and/or a communication network. Accordingly, one or more transmitted images may be stored and displayed by device 100. Device 100 may advantageously be configured to receive compressed image data and additionally configured to decompress the image data. Decompressed image data may be scaled by device 100 for display.

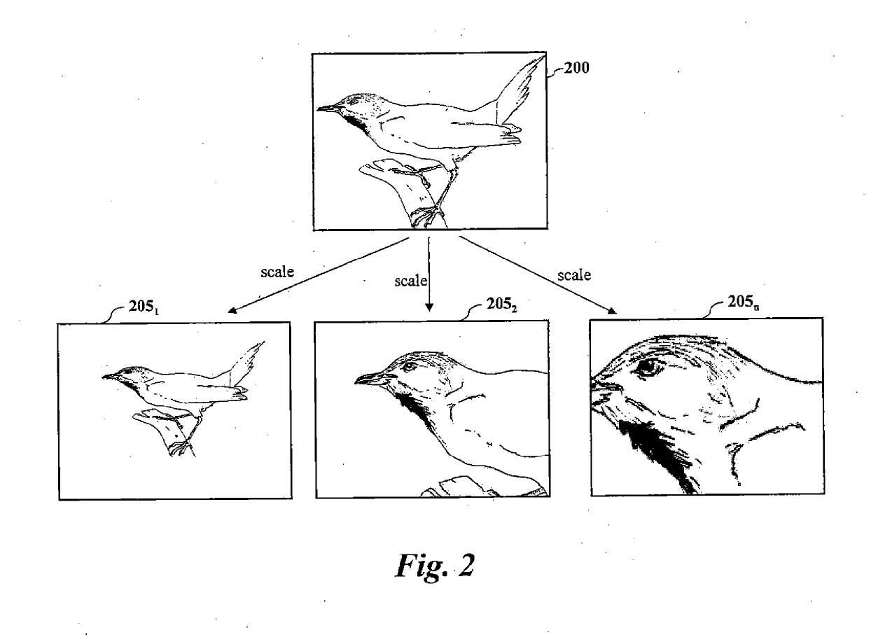

Referring now to FIG. 2, a graphical representation is depicted of image scaling by the device of FIG. 1 according to one embodiment of the invention. Image data may be scaled to allow for correct display in a display window (e.g., display 115) and/or based on resolution of the display. Image scaling may reduce memory required for storage of image data and facilitate processing of image data. Image 200 relates to a decompressed original size image which may be stored in the memory of a device (e.g., device 100). By way of example, image 200 may relate to an image as would be displayed without scaling. For certain images, the original image resolution may exceed a resolution of a display. Accordingly, the device may be configured to adjust the image for display. Alternatively, scaling may be based on the size of a display and/or image attributes. Pixel data of a sealed image may require less memory in comparison to pixel data of an original image. The device may be configured for a plurality of scale factors. As shown in FIG. 2, scaled images 205₁₋ₙ are shown according to an exemplary embodiment. Scaled images 205₁ may relate to image 200 at different scale factors. For example, image 205₁ may relate to image 200 sealed to a reduced size. By reducing the image scale, memory required for processing image data of image 205₁ may be reduced. Additionally, image size may be reduced for display on a screen of an embedded device. Images 205₂ and 205ₙ relate to exemplary scaled portions of image 200. According to another embodiment, scaling of images may be employed for reduction to generate composite data for image transitions.

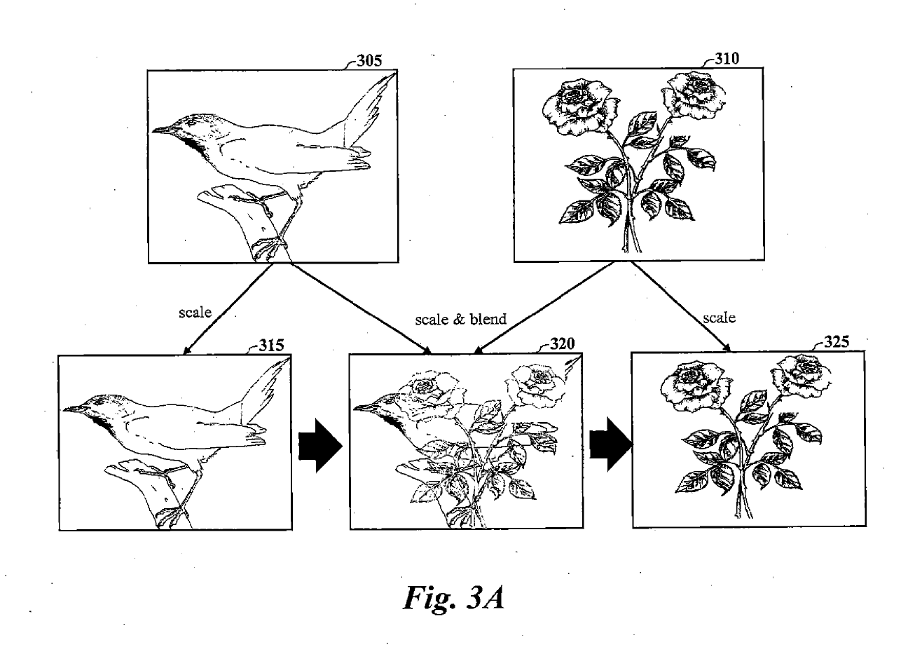

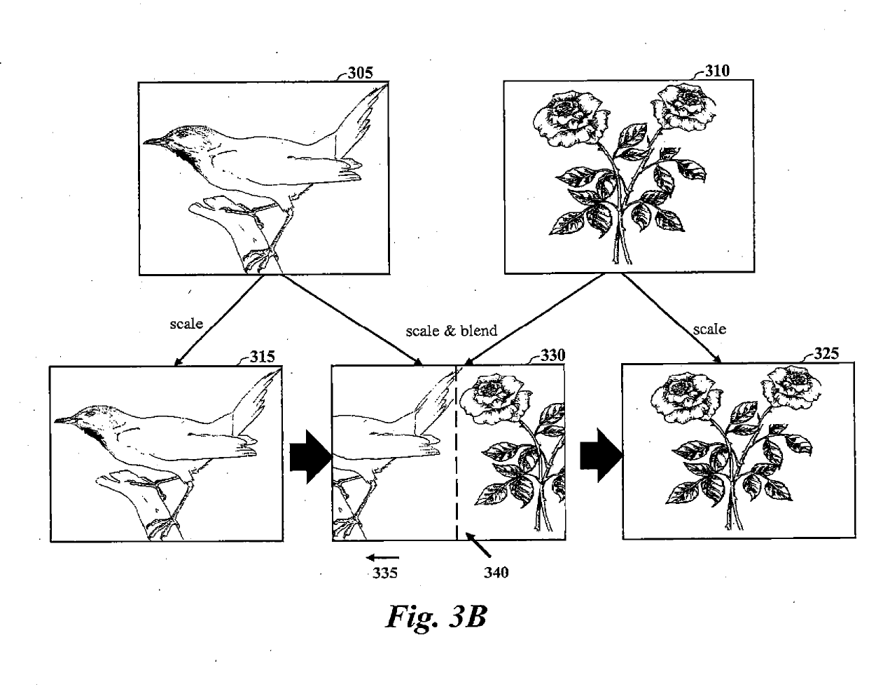

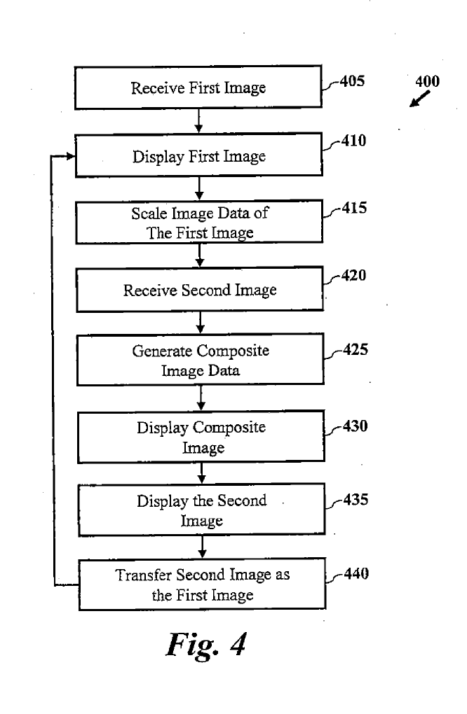

Referring now to FIGS. 3A-3B, graphical representations of image display by the device of FIG. 1 are shown. Referring first to FIG. 3A, a graphical representation of image display is depicted according to one embodiment. According to one embodiment, when a plurality of images are displayed, composite image data may be generated to provide a transition effect between display of images. By way of example, the device may receive uncompressed images 305 and 310. Alternatively, uncompressed images 305 and 310 may be retrieved from memory. According to one embodiment images 305 and 310 may be scaled for display by the device. Accordingly, the device may display a series of scaled images, shown as images 315 and 325. As will be discussed in more detail below with respect to FIG. 4, displaying a series of images can include displaying composite image data, shown as 320, to provide a transition effect. Composite image data may relate to scaled and blended image data associated with images 315 and 325. As shown in FIG. 3A, image 315 can be displayed by the device. The device may then display composite image data 320 prior to display of image 325. As further shown in FIG. 3A, composite image data 320 relates to a cross-faded image representation associated with images 315 and 325.

Composite image data 320 may be generated by the device based on a blending ratio of images 315 and 325. According to one embodiment, composite image data 320 illustrates a blend of images 315 and 325, wherein a gradual transition is displayed from image 315 to 325. In one embodiment, the blending ratio α of image 325 changes from 0 to 1, wherein the blending ratio of image 315 is 1−α. It may also be appreciated that composite image data may relate to other transition effects, including but not limited to wave transitions, ripple transitions and spiral transitions.

Referring now to FIG. 3B, a graphical representation of a scrolling effect for image transition between image 315 and 325 is shown according to another embodiment. The device can scale and blend images 315 and 325 to generate composite data for scrolling image 330. By way of example, the device may be configured to displace image data associated with image 315 horizontally (as shown by direction 335) while introducing image data associated with image 325 in scrolling image 330. For purposes of illustration, line 340 illustrates the boundary of images 315 and 325 in scrolling image 330.

Although FIGS. 3A-3B, illustrate blending and scrolling effects of images, it also be appreciated that other types of image blending may be employed by the device. It may also be appreciated that image data may relate to presentation slides and graphical displays of text according to another embodiment.

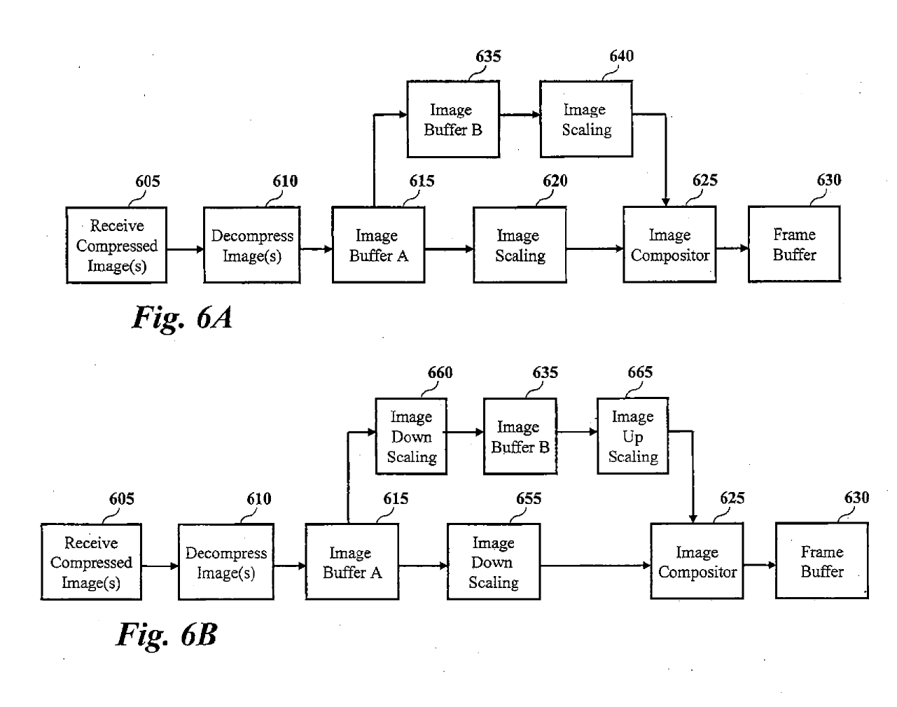

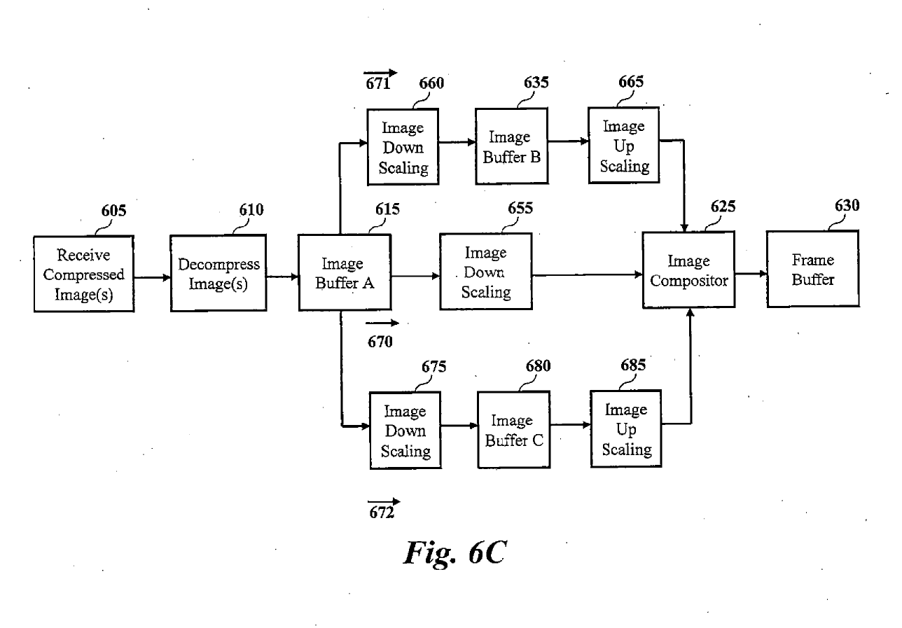

Referring now to FIG. 4, a process is depicted for displaying images according to one embodiment. Process 400 may be performed by the device of FIG. 1 to display one or more images. Process 400 may be initiated by a user command to display one or more images, wherein the device may retrieve image data via an external device and/or media stored on the device. Alternatively, the image data may be retrieved or received via a wired or wireless transmission. As will be discussed with in more detail below with reference to FIGS. 6A-6C, when the received image is compressed, the device can decompress the received image data.

According to another embodiment process 400 may be performed when a user activates a slide-show presentation on the device (e.g., digital imaging device, television, etc.). A first image may be received at block 405. Process 400 continues with display the fast image at block 410. The image may be scaled at block 415 based on resolution of a display, display window size and/or resolution of the image data.

Process 400 then proceeds to receive a second image at block 420. At block 425, the device can generate composite data based on the scaled image data associated with the first image with the second image. At block 430, the composite image may be displayed. By generating composite image data based on at least one scaled image with another image, memory required for display of a transition effect between a series of images may be reduced. Following display of the composite image data, the device can display the second image at block 435. In certain embodiments, the device may scale the second image prior to generating composite image data with the scaled image data of the first image. When additional image data is to be displayed, process 400 may transfer the second image as the first image at block 440. The image will then be treated as a first image at block 410. A subsequent image received by the device will be treated as a second image for processing as described above in connection with FIG. 4. As such, a continuous series of incoming images may be processed.

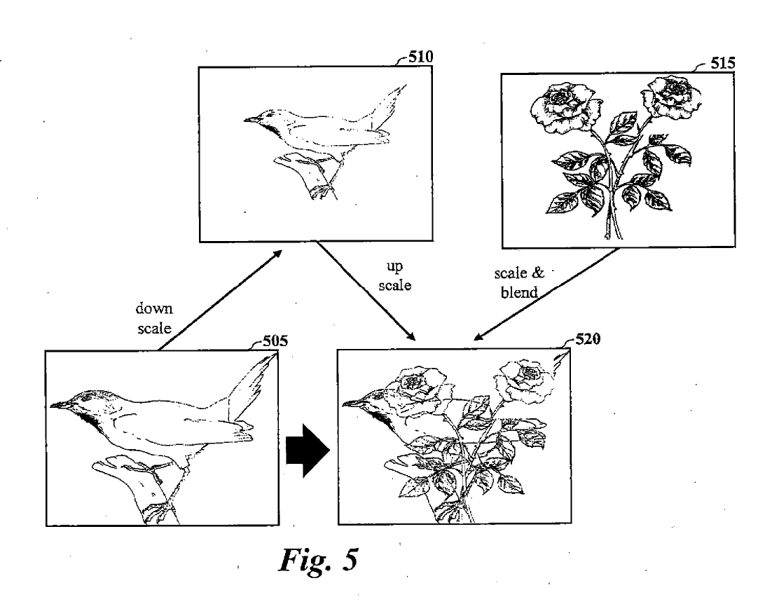

According to another embodiment, image data may be scaled below a display resolution for producing an image transition. It may be particularly advantageous to reduce the memory required for image data on embedded devices, such as digital imaging devices and personal communication devices, for image data with high resolutions. By way of example, digital devices can allow for resolution of images which demand upwards of 30 Mbytes of memory for a single image. The memory required for an embedded device may double to provide transition effects. One aspect of the invention is to overcome these requirements by scaling the image data prior to a transition. Referring now to FIG. 5, a graphical representation is depicted of image device for generating composite data according to one or more embodiments. Image 505 may be displayed by the device of FIG. 1. The device may then reduce the scale of image 505 before generating composite data. As shown, image 510 relates to a down-scaled image 505 having a reduced pixel data (e.g., memory footprint). Image 510 may then be directed or upscaled to be blended with image data associated with image 515 to generate composite image 520. The device can display composite image data 520. Because the composite image data is generated based on scaled image data associated with images 505 and 515, memory required for display of image data may be reduced.

Referring now to FIGS. 6A-6C, block diagrams are depicted for image display according to one or more embodiments. Although shown as separate blacks or described as following a block, it may be appreciated that block diagrams depict one or more data paths wherein each block may be performed and/or processed simultaneously according to one or more embodiments. Referring first to FIG. 6A, a data path or pipeline is shown according to one embodiment. At block 605 one or more compressed images may be received. In certain embodiments, transmitting devices may employ image compression for efficient use of bandwidth. Accordingly, the device may decompress the one or more images at block 610. In one embodiment, memory of the device may be allocated to provide one or more image buffers for temporary storage of image data. Decompressed image data for a first image may be stored in image buffer A at block 615. Based on one or more attributes of the image, (e.g., scale, resolution, etc.), the processor can perform image scaling at block 620 on image data of image buffer A for display. The scaled image may be passed to a frame buffer 630 for display. The image data of buffer A may also be passed to a second image buffer B at block 635. Image scaling may be performed at block 640 on the first image. When the first image is passed to buffer B, image data for a second image may be passed to image buffer A at block 615. The processor may be configured to generate composite image data in order to blend scaled image data associated with the first image and a second image at block 625. Composite image data may be provided to frame buffer 630.

According to another embodiment, image data may be down-scaled to reduce the amount of working memory required to provide image transitions. Referring now to FIG. 6B, image data of a first image may be down-scaled at block 655 before loading into a frame buffer at block 630. Additionally, the first image may be down-scaled at block 660 before loading into a second image buffer B at block 635. The image data of the first image in buffer B may be upscaled at block 665 before generating composite image data with a second image at block 625. In that fashion, memory required for storage of the first and second images may be reduced.

According to another embodiment, data for first and second images may each be down-scaled and up-scaled prior to generating a composite image. As shown in FIG. 6C, a block diagram is depicted including an additional data path according to another embodiment. Data path 672 may allow for increased processing performance by reducing memory bandwidth and data processing necessary for a transition effect with two down-scaled images with respect to memory bandwidth and data processing necessary of two original data images or one original data image and one data reduced image.

Display of an image without blending or merging may be based on a scaled image as shown in a first path 670. The first image may be output to frame buffer 630 after image down-scaling at block 655 as described above. The first image may then be down-scaled at block 660 and upscaled at block 6115 in path 671 prior to generating composite image data at block 625. A second image may be down-scaled at block 675, stored in a third image buffer C at block 680 and upscaled at block 665 in path 672 prior to generating composite image data at block 625. The image blending at block 625 will require less memory as image data for the blending and/or merging is reduced due to scaling in path 672. Composite image data may then be applied to frame buffer 630. Image data for the second image in image buffer A may then be down-scaled at block 655 and output to frame buffer at block 630. For subsequent images, the image data may be alternately processed by paths 671 and 672.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for displaying image data by a device, the method comprising the acts of:
receiving a first image by the device;
displaying the first image on a display of the device;
scaling image data of the first image, by the device, to generate sealed image data having reduced pixel data with respect to the first image;
receiving a second image by the device;
generating composite image data based on the scaled image data of the first image and image data of the second image;
displaying the composite image data on the display of the device; and
displaying the second image on the display of the device.

2. The method of claim 1, wherein scaling image data of the first image is based on at least one of screen size and resolution of the display of the device, wherein the resolution of the scaled image data is lower than the resolution of the first image.

3. The method of claim 1, wherein scaling image data of the first image relates to down-scaling image data of the first image and upscaling the down-scaled image data.

4. The method of claim 1, wherein the scaled image data of the first image relates to image data associated with the size and features of the first image at a lower resolution.

5. The method of claim 1, wherein the composite image data relates to one of blending and scrolling transition between of the scaled image data of the first image and image data associated with the second image, wherein the composite image data is displayed during a transition period between display of the first image and second image.

6. The method of claim 1, wherein displaying composite data relates to display of the composite date for a predetermined of time period which is less than a display period for each of the first and second images.

7. The method of claim 1, further comprising storing the scaled image data of the first image in a buffer.

8. The method of claim 1, further comprising scaling image data of the second image and storing the scaled image data of the second image in a buffer to generate composite image data.

9. The method of claim 8, further comprising upscaling image data of the first and second images for generating, the composite image data.

10. The method of claim 1, further comprising storing image data for output by the display device in a frame buffer.

11. A display device comprising:
a display configured to output image data; and
a processor coupled to the display, the processor configured to:
receive a first image by the device;
output the first image to the display;
scale image data of the first image, by the device, to generate scaled image data having reduced pixel data with respect to the first image;
receiving a second image by the device;
generating composite image data based on the scaled image data of the first image and image data of the second image;
output the composite image data to the display; and
output the second image to the display.

12. The device of claim 11, wherein the processor is configured to scale image data of the first image is based on at least one of screen size and resolution of the display; wherein the resolution of the scaled image data is lower than the resolution of the first image.

13. The device of claim 11, wherein the processor is configured to scale image data of the first image by down-scaling image data of the first image and upscaling the down-scaled image data.

14. The device of claim 11, wherein, the scaled image data of the first image relates to image data associated with the size and features of the first image at a lower resolution.

15. The device of claim 11, wherein the composite image data relates to one of blending and scrolling transition between of the scaled image data of the first image and image data associated with the second image, wherein the composite image data is displayed during a transition period between display of the first image and second image.

16. The device of claim 11, wherein displaying composite data relates to display of the composite date for a predetermined of time period which is less than a display period for each of the first and second images.

17. The device of claim 11, wherein the processor is further configured to store the scaled image data of the first image in a buffer.

18. The device of claim 11, wherein the processor is further configured to scale image data of the second image and store the scaled image data of the second image in a buffer to generate composite image data.

19. The device of claim 18, wherein the processor is further configured to upscale image data of the first and second images for generating the composite image data.

20. The device of claim 11, wherein the processor is further configured to store image data for output by the display device in a frame buffer.
